(19) United States
(12) Patent Application Publication
(10) Pub. No.: US 2014/0012691 A1
(43) Pub. Date: Jan. 9, 2014

(54) TRANSACTION MONITORING AND SAVINGS FEATURE

(71) Applicants: Carrie Anne Hanson, Charlotte, NC (US); Scott R. Enscoe, Charlotte, NC (US); Alexander C. Wittkowski, Charlotte, NC (US); David M. Grigg, Rock Hill, SC (US); Daniel David, Charlotte, NC (US); Katherine Dintenfass, Charlotte, NC (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(72) Inventors: Carrie Anne Hanson, Charlotte, NC (US); Scott R. Enscoe, Charlotte, NC (US); Alexander C. Wittkowski, Charlotte, NC (US); David M. Grigg, Rock Hill, SC (US); Daniel David, Charlotte, NC (US); Katherine Dintenfass, Charlotte, NC (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(73) Assignee: BANK OF AMERICA CORPORATION, Charlotte, NC (US)

(21) Appl. No.: 13/543,619

(22) Filed: Jul. 6, 2012

(51) Int. Cl. G06Q 20/42; G06Q 20/20; G06Q 20/22

(52) U.S. Cl. 705/21; 705/39; 705/44

(57) ABSTRACT

Systems and methods for monitoring categorized spending limits and promoting savings are provided herein. The systems and methods, identify transactions associated with a spending category that occur during a period of time based on the transaction data, where the spending category comprises a spend limit; provide a confirmation prompt on a display of a mobile device of a user that is in communication with the system; and deduct a transaction amount for each of the transactions from the spend limit in response to receiving a confirmation from the user.

### BACKGROUND

Consumers typically shop at many different businesses from day to day and usually purchase a large variety of goods and services. Keeping track of receipts, amounts, and items purchased can be considerably time consuming and cumbersome for consumers on a budget. Bank account statements often provide transaction information about transactions that occurred over the past month, but contain an overwhelming amount of information for the user to organize, and thus, do not help the consumer reduce spending.

### BRIEF SUMMARY

The embodiments provided herein are directed to a system for monitoring categorized spending maximums. The system includes a computer apparatus including a processor and a memory; and a spending monitor software module stored in the memory, comprising executable instructions that when executed by the processor cause the processor to: receive transaction data associated with an account; store the transaction data in a storage device; identify transactions associated with a spending category that occur during a period of time based on the transaction data, wherein the spending category comprises a spend maximum; deduct a transaction amount for each of the transactions from the spend maximum; determine a remaining amount of the spend maximum, if any; and transfer at least a portion of the remaining amount to a second account when the remaining amount is determined.

In some embodiments of the system, the module is further configured to: provide a confirmation prompt on a display of a mobile device of a user that is in communication with the system; and deduct a transaction amount for each of the transactions from the spend maximum in response to receiving a confirmation from the user. The module can be further configured to: transfer a first portion of the remaining amount to a second account and a second portion of the remaining amount to a third account. In other embodiments, the transfer of the first portion of the remaining amount comprises an internal transfer and the transfer of the second portion of the remaining amount comprises an external transfer.

In other embodiments of the system, the module is configured to: determine the total transaction amount of the transactions at the end of the period of time; and calculate the difference of the total transaction amount of the transactions and the spend maximum, wherein the total transaction amount is greater than the spend maximum. The module can be further configured to deduct funds equal to the difference from a second spend maximum associated with a second spending category. The module can be further configured to deduct funds equal to the difference from the first account; and transfer the funds to a second account. The module can be further configured to deduct funds equal to the difference from the spend maximum for transactions associated with the spending category that occur during a second period of time, wherein the first period of time is prior to the second period of time. The module can be further configured to recommend an increase in the spend maximum to the user.

In other embodiments of the system, the module is configured to: identify a group of transactions that occurs during a second period of time that is prior to the first period of time; identify parameters based on the group of transactions, wherein the parameters comprise a transaction channel, a merchant, an amount, or a transaction item; and determine the spending category based on the parameters. The module can be further configured to: segregate the group of transactions into categories based on the parameters; calculate the total amount for each of the categories; and determine the spend maximum based on at least one of the total amount calculations. The module can be further configured to: determine that the spending category comprises subcategories based on transaction items or a merchant associated with the transactions; segregate the transactions into each of the subcategories; calculate the total number or value of the transactions for each of the subcategories; and provide a notification of the user based on the calculation of the total number of value of the transactions.

In some embodiments, a method for monitoring categorized spending maximums is provided. The method includes: receiving transaction data associated with a first account; identifying, via a computing device processor, transactions associated with a spending category that occur during a period of time based on the transaction data, wherein the spending category comprises a spend maximum; providing, via a computing device processor, a confirmation prompt on a display of a mobile device of a user that is in communication with the system; deducting, via a computing device processor, a transaction amount for each of the transactions from the spend maximum in response to receiving a confirmation from the user; determining, via a computing device processor, a remaining amount of the spend maximum in response to the deductions of the transaction amount for each of the transactions; and transferring, via a computing device processor, at least a portion of the remaining amount to a second account.

In some embodiments of the method, the method includes: transferring, via a computing device processor, a first portion of the remaining amount to a second account and a second portion of the remaining amount to a third account. In other embodiments, the transfer of the first portion of the remaining amount comprises an internal transfer and the transfer of the second portion of the remaining amount comprises an external transfer. The method can further include: determining, via a computing device processor, that the remaining amount is above an amount threshold; and transferring, via a computing device processor, a portion of the remaining amount to a third account of a second user in response to determining that the remaining amount is above the amount threshold. In still other embodiments of the method, the transaction data is received from a point of sales device.

Also provided in the embodiments presented herein is a computer program product for monitoring categorized spending maximums, the computer program product comprising: a computer readable storage medium having computer readable program code embodied therewith, the computer readable program code comprising: a computer readable program code configured to receive transaction data associated with a first account; a computer readable program code configured to identify transactions associated with a spending category that occur during a period of time based on the transaction data, wherein the spending category comprises a spend maximum; a computer readable program code configured to provide a confirmation prompt on a display of a mobile device of a user that is in communication with the system; a computer readable program code configured to deduct a transaction amount for each of the transactions from the spend maximum in response to receiving a confirmation from the user; a computer readable program code configured to determine a remaining amount of the spend maximum in response to the deductions of the transaction amount for each of the transactions; and a computer readable program code configured to transfer at least a portion of the remaining amount to a second account. In some embodiments, the computer program product further includes: computer readable program code configured to transfer a first portion of the remaining amount to a second account and a second portion of the remaining amount to a third account.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1A is a flowchart illustrating a method for monitoring transactions and transferring funds in accordance with various embodiments of the invention;

FIG. 1B is a continuation of the flowchart from FIG. 1A illustrating a method for monitoring transactions and transferring funds in accordance with various embodiments of the invention;

FIG. 2 is a transaction monitoring system and environment in accordance with various embodiments of the invention;

FIG. 3 provides a block diagram illustrating the user's mobile device of FIG. 2 in accordance with various embodiments of the invention;

FIG. 4 provides a block diagram illustrating the transaction monitor server of FIG. 2, in accordance with various embodiments of the invention;

FIG. 5 provides a block diagram illustrating the financial institution's banking system of FIG. 2, in accordance with various embodiments of the invention;

FIG. 6 is a graphical user interface of a mobile device illustrating a process of monitoring transactions in accordance with various embodiments of the invention;

FIG. 7 is a graphical user interface of a mobile device illustrating a process of monitoring transactions in accordance with various embodiments of the invention; and

FIG. 8 is a graphical user interface of a mobile device illustrating a process of monitoring transactions in accordance with various embodiments of the invention.

### DETAILED DESCRIPTION

The embodiments presented herein are directed to systems and methods for monitoring transactions and transferring funds. A transaction monitoring and savings feature allows a user to set and monitor periodic spending maximums for specific categories. This feature aids the user in reducing spending for a specific spending category. Systems and methods identify transactions that are related to the spending category and prompt the user to confirm the transaction and category. At the end of the time period, if the total spending amount is less that the spend maximum, the system automatically deposits the surplus into the user's savings account or other account. In some instances, the user may choose to repeat the budgeting process for another period of time.

As will be appreciated by one skilled in the art, aspects of the present embodiments of the invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the invention are described below with reference to flowchart illustrations and/or block diagrams of methods, apparatus (systems) and computer program products according to embodiments of the embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As presented herein, embodiments that monitor transactions and promote savings are provided. Setting up a budget and monitoring transactions can be overwhelming for a user. Increasing savings through small steps gives the user a feeling of financial empowerment and control in areas where the user feels he or she can easily impact. In a mobile application embodiment, manual tagging specific categories of spending using a mobile application stored in the user's mobile device can become a meaningful activity in the user's spare moments throughout the day. The embodiments also benefit the party providing the systems and method, such as a financial institution, by increasing the user's mobile product adoption, deepening the financial institution's relationship with the user, and reducing service costs. Through the embodiments, the financial institution establishes itself as a key partner in supporting responsible spending and increasing the user's savings.

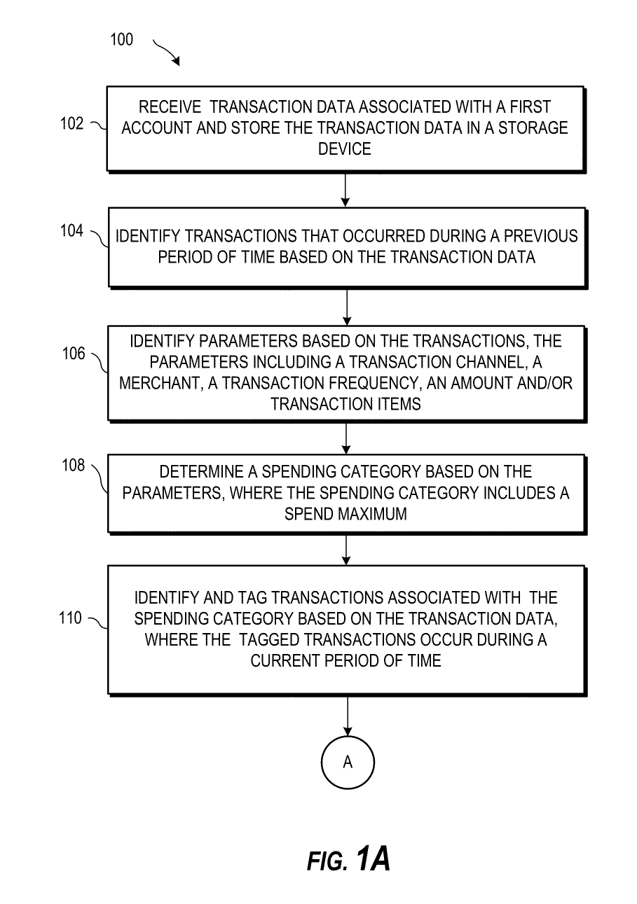

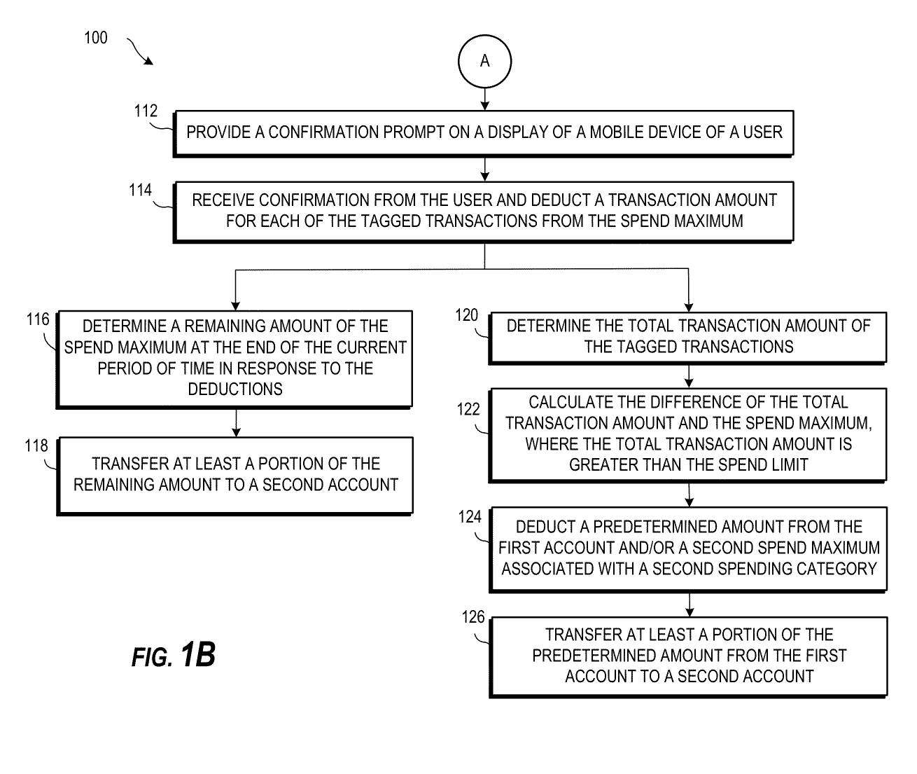

FIGS. 1A-1B are flowcharts providing an overview of a method 100 for monitoring transactions and transferring funds. One or more devices, such as one or more mobile devices and/or one or more other computing devices and/or servers, can be configured to perform one or more steps of the method 100. In some embodiments, the one or more devices performing the steps are associated with a financial institution. In other embodiments, the one or more devices performing the steps are associated with a business, partner, third party, and/or user.

As shown in FIG. 1A, and as illustrated at block 102, the system receives transaction data associated with a first account and stores the transaction data in a storage device (e.g., the user account data repository 580, the transaction monitor data store 470, or other data storage). It will be understood that the first account may comprise one or more accounts. As used herein, “transaction data” includes, but is not limited to any data associated with one or more financial accounts such as transaction amounts, inbound transactions, outbound transactions, transaction channels, transaction dates, identification of third parties to a transaction, payee names, purpose of transactions, transaction transfer data, types of accounts, terms of an account, terms of a transaction, identification of items purchased, transaction costs, account costs, merchant based or product based promotions, rewards associated with an account, and the like. The transaction data may be received from a user 210, merchants, other financial institutions such as credit card companies, or any other entity. For example, the transaction data may be communicated from a point of sales (POS) device of a merchant and/or a mobile device of a user 210.

As illustrated in block 104, the system identifies transactions that occurred during a previous period of time based on the transaction data. The transactions include inbound transactions, outbound transactions, internal transfers, outbound transfers, and combinations thereof. Exemplary transactions include purchases made online and/or at a physical location, ATM withdrawals, electronic funds transfers such as automatic bill pay, mobile transactions using a mobile wallet application stored on a mobile device, cloud-based payments, and the like. The previous period of time includes any period of time that occurs before a current period of time. The previous period of time includes a year, a month, a week, a day, specific days in a week, specific weeks in a month, and the like. For example, the system may monitor every Friday in a particular month or focus on months associated with a season or events such as tax season, the holiday season, or the summer months.

As illustrated in block 106, the system identifies parameters based on the transactions, the parameters including a transaction channel, a merchant, an amount, a frequency, and/or transaction items. The transaction channel includes transaction vehicles or accounts associated with the vehicles for processing transactions. Exemplary transaction channels include debit card accounts, credit card accounts, automatic teller machines (ATM) channels, automated clearinghouse (ACH) channels, checking accounts, savings accounts, internal accounts, external accounts, investment vehicle accounts, mobile payment channels, cloud-based payment channels, and the like. The merchant includes online, virtual, and/or brick and mortar businesses, manufacturers, and the like. The merchant may be identified using merchant codes associated with processing payments. The amount, in some embodiments, includes a total amount of a transaction or at least a portion of the total amount of the transaction. For example, the total purchase amount of a transaction may be divided among the costs of each item or group of items in the transaction. The amount may include, for example, the price of each item, fees associated with a transaction, the amount transferred between the parties of a transaction, taxes, interest, account costs, refunds, and the like.

The transaction items include items for purchase such as goods and/or services. The transaction items, in some embodiments, are segregated into groups and/or sub-groups. For example, prepared foods may be separated from unprepared foods, electronic reading materials may be separated from paper magazine and books, and certain goods and services purchased may be segregated into various sub-groups based on the merchant associated with the certain goods and services.

The merchant includes business such as a brick and mortar store, a virtual store, or an online store that provides and/or sells the items to the user. The merchant may be identified based on merchant codes, POS identifiers, geographical location (e.g., merchant address), and the like. In some embodiments, the parameters include a geographical location. For example, the parameters may include transaction or merchants associated with a particular address, town, state, or area. The transaction frequency includes the number of times certain transactions occur over a certain period of time. For example, the transaction frequency may include the number of times certain transactions occur during at least a portion of the previous period of time.

Algorithms, rules, keywords, Boolean, and other search logic can be used to search the transaction data to identify the transaction channel, merchant, amount, and/or transaction items. Keywords may include certain product identifying terms, business names, web addresses, symbols (e.g., $), merchant codes, and the like. In some embodiments, a first parameter is identified based on transactions that occur during a first period of the previous period of time and a second parameter is identified based on transactions that occur during a second period of time. For example, the system may determine that an electronic funds transfer of $65.12 occurs during the last week of every month while the timing of restaurant purchases using various credit cards may vary considerably from day to day or week to week. In such cases, the system may only monitor the last week of every month to determine a parameter associated with automatic bill pay and may monitor restaurant purchases on a daily basis to identify a food related parameter.

As illustrated in block 108, the system determines a spending category based on the parameters, where the spending category includes a spend maximum. In some embodiments, the spending category is defined by the one or more parameters. For example, the spending category may be defined by merchant codes and/or items purchased. A spending category directed to shoes and accessories may be defined as including purchases at particular shoe store and/or purchases for shoes and accessories. The shoes and accessories spending category can be further defined to include a certain transaction channel such as credit cards and a purchase threshold amount of greater than, less than, or equal to a certain amount. As explained in more detail below with regard to FIG. 1B, the spending category may be further defined by a current period of time.

In some embodiments, the spending category is determined based on user preferences. For example, a user 210 may set up and define the spending category and/or spending maximum. In some embodiments, the user 210 chooses from a list of recommended spending categories. The user 210 may, for example, choose parameters to define a selected spending category or select default parameters of the spending category. In other embodiments, the user 210 inputs the spending category and inputs parameters to define the spending category.

In additional embodiments, the spend maximum of the spending category is defined by the parameters. The transactions, in some embodiments, are segregated into categories based on the parameters and the total amount for each of the categories is calculated. Based on at least one of the total amount calculations, the spend maximum is determined. For example, the sum of all transactions that include only purchases of electronics, purchases using a mobile wallet, or purchases at a particular chain of stores, may be calculated to determine the amount of the spending maximum. The spending maximum, in some embodiments, is equal to, greater than or less than the total amount for each of the categories.

In other embodiments, the spend maximum is determined based on patterns of account activity associated with the first account. The patterns of account activity include positive and negative trends associated with the transaction data. For example, the spend maximum of a spending category directed to utilities may be increased in the summer months to reflect an increase in electricity use and decreased in the spring and fall months when electricity use is on a decline. As another example, the system may determine from the transaction data that credit card payment amounts for entertainment peak on Fridays and as a result may increase the spend maximum for Fridays and/or decrease the spend maximum for the other weekdays. The system may further determine a decrease in the number of ATM withdrawals and/or purchases during the last week of a month when compared to the first three weeks of the same month and adjust a weekly transaction frequency accordingly.

In still other embodiments, the system predicts future spending and account activity. For example, the system may use certain account or transactional information associated with a user to identify projected expenses, projected transfers of funds, projected account balances, projected payments and/or projected credits. The future account activity system and method is described in more detail with reference to patent application no. [to be inserted when said application is known] entitled “Future Account View” corresponding to attorney docket no. 5175US1.014033.1651.

As illustrated in block 110, the system identifies and tags transactions associated with a spending category based on the transaction data, where the tagged transactions occur during a current period of time. The previous period of time of block 104 occurs prior to the current period of time. In some embodiments, the current period of time is set automatically. In other embodiments, the current period of time is determined based on the patterns of account activity of the first account. For example, spending categories associated with a large amount of variability such as fluctuating amounts and different transaction channels or merchants may have a shorter current period of time (e.g., a week or a day) than spending categories that are more stable over time. The parameters of the spending category are used to identify the transactions. In such cases, rules, algorithms, key word searches, and the like relating to the parameters can be used to identify the transactions. In other embodiments of the invention a user 210 may set the current period of time for the spending category, as is desired by the user 210.

The method 100 is further illustrated in FIG. 1B. As illustrated in block 112, the system provides a confirmation prompt on a display of a mobile device of a user 210. The confirmation prompt enables a user 210 to confirm that a transaction tagged by the system is associated with the spending category. In some embodiments, the system modifies at least a portion of the tagged transaction in response to user input. For example, the confirmation prompts may include fields that allow the user 210 to input modifications to the tagged transaction data. The user 210 may, for example, increase or decrease the amount of the tagged transaction, assign the tagged transaction to another spending category, or create a new spending category to place the tagged transaction. The system may, for example, determine that only one item of several items purchased falls under the spending category and may only tag a portion of the total purchase amount that corresponds to the one item. The user 210 can adjust the amount of the tagged transaction using the confirmation prompt or can otherwise modify the items purchased in the tagged transaction. In other embodiments, the user 210 can input exception rules in designated fields of the confirmation prompt. For example, the user 210 may exclude certain days or hours from the current time period, designate items to include or exclude from the spending category, and the like.

As illustrated in block 114, the system receives confirmation from the user 210 and deducts a transaction amount for each of the tagged transactions from the spend maximum. The transaction amount can be the amount determined by the system or the amount modified by the user 210 using the confirmation prompt on the display of the user's mobile device. In some embodiments, the system determines the transaction amount based on historical trends in the transaction data. In such cases, the system identifies transactions that occurred during the previous period of time that are associated with the parameters of the spending category. The system further determines the transaction amount for each of the identified transactions that occurred during the previous period of time and calculates an average amount for the identified transactions.

In some embodiments, the transaction amount for each of the tagged transactions comprises the calculated average amount of identified transactions that occurred during the previous period of time. In such cases, the transaction amount may be, for example, the same for each of the tagged transactions of the current period of time regardless of the amount, items, or merchant associated with the tagged transaction. For example, if the average transaction amount for purchases in an entertainment category was $13.76 last week, the system may round up the average transaction amount and set the amounts of the entertainment transactions identified during the current week as $14.00. As another example, the transaction amount may be greater than or less than the calculated average amount. The calculated average amount may also be periodically adjusted to account for various fluctuations such as user preferences, seasons, sales, and inflation. In other embodiments, the transaction amount of each of the tagged transactions includes at least a portion of the actual transaction amount for each of the tagged transactions.

As illustrated in block 116, the system determines a remaining amount of the spend maximum at the end of the current period of time in response to the deductions. The remaining amount is a surplus that remains after all the deductions have been inputted at the end of the current period of time. The remaining amount is calculated as the difference of the total transaction amount of all of the tagged transactions and the spend maximum, where the total transaction amount is less than the spend maximum.

As illustrated in block 118, the system transfers at least a portion of the remaining amount to a second account. Exemplary second accounts include savings accounts, checking accounts, retirement accounts, investment vehicles, and the like. The system may, for example, recommend a second account to the user 210 based on various account interest rates, account balances, the age of the user 210, the ages or status of the user's family members, debts, account balances, types of loans held by the user 210, and the like. In some instances, the system may determine that the second account has reached a maximum such that no further funds may be transferred to that second account. For example, some retirement accounts and investment vehicles may provide a maximum for how much money can be put into the account in a year. In other embodiments, the second account and the amount to be transferred to the second account is based on the number of transactions associated with the spending categories. The user 210 may, for example, want to limit or increase the number of times they visit a particular store, limit or increase the amount of time spent at that store, and/or limit the number of times certain items are purchased. The system may transfer the remaining amount to an external account, such as an account held by a charitable organization upon the occurrence of a transaction that the user 210 wants to limit (e.g., if the user 210 purchases fast food more than three times in a week). In another example, the system may transfer at least portion of the remaining amount to a checking account of the user 210 upon the occurrence of a transaction that the user 210 wants to encourage (e.g., if the user 210 uses a particular credit card that has a rewards program in order to make purchases every day during a two week period on the card).

In some embodiments, the second account is associated with the user 210 while in other embodiments the second account is associated with a second user. For example, the entire remaining amount or a portion thereof may be transferred to a checking account of a family member of the user 210. In another example, the remaining amount or a portion thereof may be transferred to an investment vehicle maintained by the user 210 for the benefit of a second user. In one example, the remaining amount or a portion of the remaining is only transferred if it is determined that the total remaining amount is greater than, less than, or equal to an amount threshold. A user 210, for example may only want to transfer the remaining amount to a college savings account for the user's child if the remaining amount is under $50.

The transfer potentially includes internal transfers and external transfers. For example, the second account may be associated with the financial institution maintaining the first account or a second financial institution. The remaining amount can be divided and the divided portions can be transferred to any number of accounts. For example, 25% of the remaining amount may be transferred to the first account and 25% of the remaining amount may be transferred to an external account, and the remaining amount may be transferred to an internal investment vehicle. The divided portions may, in some instances, be adjusted according to user preferences, seasonal trends, and the like. For example, during the holiday season, the user 210 may elect to stop the system from transferring at least a portion of the remaining amount to a second account such that 100% of the remaining amount may be transferred to the first account during the month of December.

In other embodiments, a predetermined amount is transferred from the first account to the second account. The system, in some embodiments, determines if the remaining amount is equal to, greater than, or less than the predetermined amount. If the remaining amount is less than the predetermined amount, for example, the system may deduct enough funds from the first account to bring the remaining amount up to the predetermined amount and transfer the deducted funds to the second account. It will be understood that the transaction data may include transactions associated with any number of spending categories. For example, the system may calculate the total remaining amount for all tagged transactions associated with any number of spending categories during the current period of time and transfer at least a portion of the total remaining amount to the second account.

As illustrated in blocks 120-122, the system determines the total transaction amount of the tagged transactions and calculates the difference of the total transaction amount and the spend maximum, where the total transaction is greater than the spend maximum. As shown in block 124, the system deducts a predetermined amount from the first account and/or a second spend maximum associated with a second category. In some embodiments, the predetermined amount comprises at least a portion of the calculated difference. The predetermined amount can be greater than, less than, or equal to the calculated difference.

In some embodiments, the second spend maximum occurs during the current period. For example, the second spend maximum may be part of a second spending category that is separate and includes different parameters than the first spending category. In some embodiments, at least a portion of the difference is deducted from the first spend maximum of the first spending category during a future period of time. For example, the difference may be subtracted from the first spend maximum of the first spending category for transactions that occur during the very next period of time or the difference may be divided and the divided portions of the difference may be subtracted from the first spend maximums of the first spending categories that occur during any number of future periods of time. The future period of time is a period of time that occurs after the current period of time.

As illustrated in block 126, the system transfers at least a portion of the predetermined amount from the first account to a second account. In other embodiments, the system transfers at least a portion of the predetermined amount from an account other than the first account. For example, the system may transfer the entire predetermined amount from an external account maintained by a second financial institution to the second or first account. It will be understood that the system may transfer the predetermined amount or a portion thereof from any number of primary accounts to any number of secondary accounts. For example, the system may transfer the predetermine amount from various checking accounts to various savings accounts.

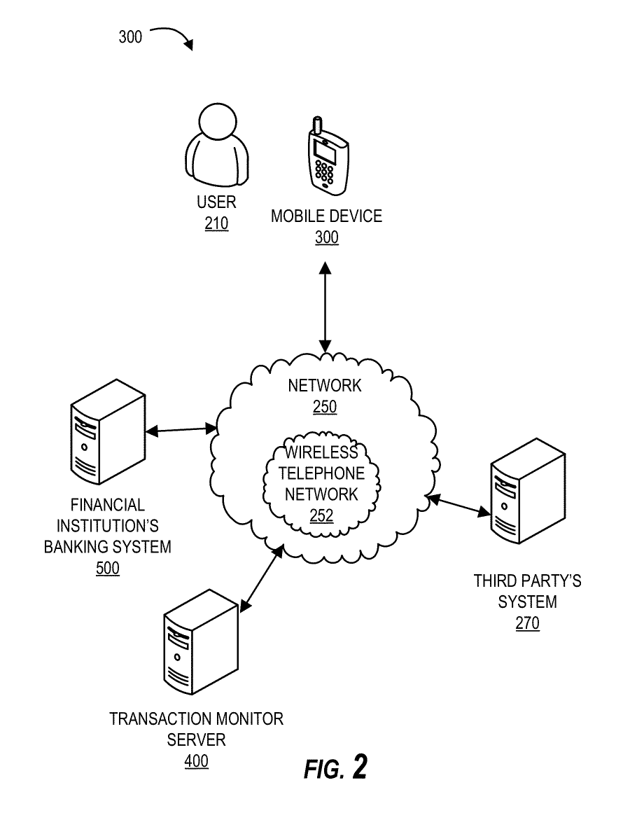

FIG. 2 provides a block diagram illustrating a transaction monitoring system and environment 200, in accordance with an embodiment of the invention. As illustrated in FIG. 2, the environment 200 includes the user 210 and the user's mobile device 300. As used herein, a “mobile device” 300 is any mobile device, such as a cellular telecommunications device (i.e., a cell phone or mobile phone or smart phone), personal digital assistant (PDA), a mobile Internet accessing device, or other mobile device. In some embodiments, the mobile device 300 employs a processor and memory and can perform computing functions.

The mobile device 300 is configured to communicate over a network 250 with the financial institution's banking system 500 and, in some cases, a third party's system 270. The third party's system 270 includes systems associated with a merchant, third party financial institutions, and/or other third parties. The network 250 may include a local area network (LAN), a wide area network (WAN), and/or a global area network (GAN). The network 250 may provide for wireline, wireless, or a combination of wireline and wireless communication between devices in the network. In one embodiment, the network 250 includes the Internet. In one embodiment, the network 250 includes a wireless telephone network 252. In further embodiments, the network 250 includes a near field communication (NFC) network.

In general, the mobile device 300 is configured to connect with the network 250 to log the user 210 into the banking system 500. In some embodiments, the banking system 500 involves authentication of the user 210 in order to access the user's account on the banking system 500. For example, the banking system 500 may be a system where the user 210 logs into his/her account such that the user 210 or other entity can access data that is associated with the user 210. In some embodiments, the banking system 500 is a mobile banking system maintained by a financial institution. In such an embodiment, the user 210 can use the mobile device 300 to log into the mobile banking system to access the user's financial accounts. Logging into the banking system 500 generally requires that the user 210 authenticate his/her identity using a user name, a passcode, a cookie, a biometric identifier, a private key, a token, and/or another authentication mechanism that is provided by the user 210 to the banking system 500. In some embodiments, the user 210 logs into his or her account via a mobile wallet application stored on the use's mobile device.

The financial institution's banking system 500 is in network communication with other devices, such as the third party's systems 270, a transaction monitor server 400, and a point of sales (POS) device (not shown) that is configured to communicate with the network 250 to log the merchant into the banking system 500. In an embodiment, the point-of-sale device is a Near-Field Communication (NFC), and/or wireless enabled device or another type of device capable of communicating with the mobile device 300 of the user 210. In an embodiment, the point-of-sale device includes a NFC chip capable of syncing with and/or communicating with another NFC chip in the vicinity of the point-of-sale device. In a further embodiment, the point-of-sale device may be network-enabled and able to communicate with the user's device 300 over a wireless network or via Bluetooth™. In another embodiment, the point-of-sale device communicates with the banking system 500, which in turn communicates the mobile device 300, and thus communication is enabled between all devices on the network 250 through relays.

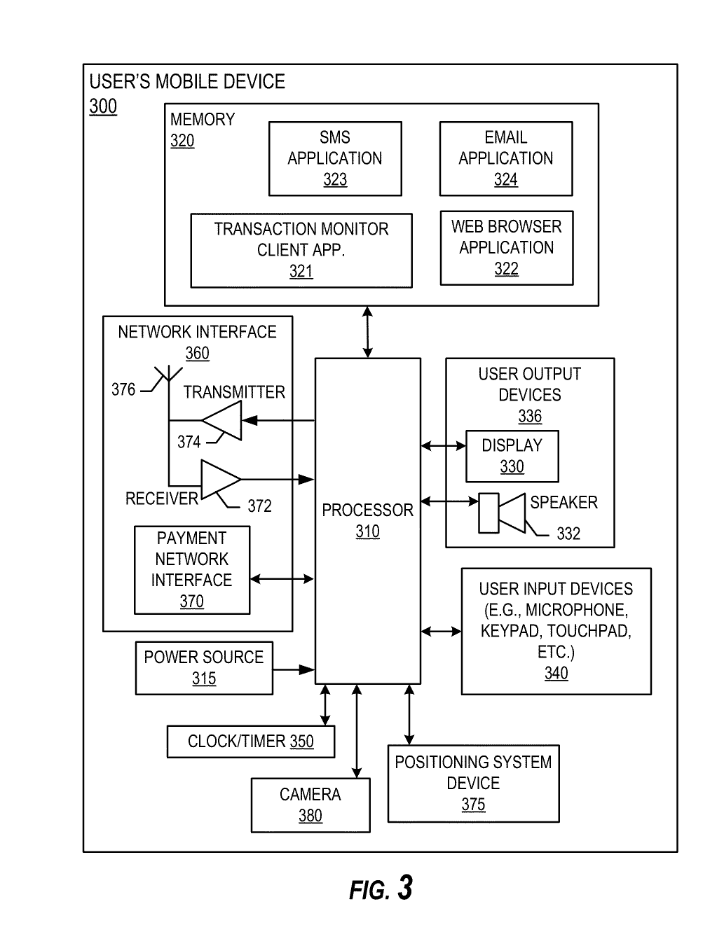

FIG. 3 provides a block diagram illustrating the mobile device 300 of FIG. 2 in more detail, in accordance with embodiments of the invention. In one embodiment of the invention, the mobile device 300 is a mobile telephone. However, it should be understood that a mobile telephone is merely illustrative of one type of mobile device that may benefit from, employ, or otherwise be involved with embodiments of the present invention and, therefore, should not be taken to limit the scope of embodiments of the present invention. Other types of mobile devices 300 may include portable digital assistants (PDAs), pagers, mobile televisions, gaming devices, laptop computers, cameras, video recorders, audio/video player, radio, GPS devices, or any combination of the aforementioned.

The mobile device 300 generally includes a processor 310 communicably coupled to such devices as a memory 320, user output devices 336, user input devices 340, a network interface 360, a power source 315, a clock or other timer 350, a camera 380, and a positioning system device 375. In an embodiment, the network interface 360 includes a Near Field Communication device capable of communicating with other NFC enabled devices. The NFC device is capable of short range wireless transfer of data. In some embodiments, the range of the NFC signal is intentionally reduced such that the NFC signal is unlikely to be accessible to any NFC devices other than the NFC device that the user 210 touches with the mobile device. In some embodiments, the NFC device generates a radio frequency (RF) field that is capable of powering another NFC device. In one embodiment, the NFC device on the mobile device is powered, such as by the power source for the mobile device or by a dedicated power source. In another embodiment, the NFC device on the mobile device is not powered and receives power from the NFC device associated with the point-of-sale device. In a still further embodiment, both the NFC device on the mobile device and the NFC device on the point-of-sale device are actively powered. In an embodiment, the NFC device on the mobile device does not need to be paired with the NFC device at the point-of-sale prior to transferring data. In some embodiments, the NFC device encrypts the data prior to transferring the data.

The processor 310 and other processors described herein generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 250. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. The signals may include signaling information in accordance with the air interface standard of the applicable cellular system of the wireless telephone network 252. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN), Bluetooth™ network, or other communication/data networks.

The network interface 360 may also include a payment network interface 370. The payment network interface 370 may include software, such as encryption software, and hardware, such as a modem, for communicating information to and/or from one or more devices on the network 250. For example, the mobile device 300 may be configured so that it can be used as a credit or debit card by, for example, wirelessly communicating account numbers or other authentication information to a terminal of the network 250.

As described above, the mobile device 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the mobile device 300 to receive data from a user, such as the user 210, may include any of a number of devices allowing the mobile device 300 to receive data from a user 210, such as a keypad, keyboard, touch-screen, touchpad, microphone, mouse, joystick, other pointer device, button, soft key, and/or other input device(s). The user interface may also include a camera 380, such as a digital camera.

The mobile device 300 may also include the positioning system device 375 that is configured to be used by a positioning system to determine a location of the mobile device 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate location of the mobile device 300. In other embodiments, the positioning system device 375 includes a proximity sensor or transmitter, such as an RFID tag, that can sense or be sensed by devices known to be located proximate a merchant or other location to determine that the consumer mobile device 300 is located proximate these known devices.

The mobile device 300 further includes a power source 315, such as a battery, for powering various circuits and other devices that are used to operate the mobile device 300. Embodiments of the mobile device 300 may also include a clock or other timer 350 configured to determine and, in some cases, communicate actual or relative time to the processor 310 or one or more other devices.

The mobile device 300 also includes the memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile device 300 described herein. For example, the memory 320 may include such applications as a conventional web browser application 322, an SMS (text) application 323, an email application 324, and/or a transaction monitor client application 321. These applications also typically provide a graphical user interface (GUI) on the display 330 that allows the user 210 to communicate with the user's mobile device 300, the banking system 500, and/or other devices or systems. In one embodiment of the invention, when the user 210 decides to enroll in the mobile banking program, the user 210 downloads or otherwise obtains the mobile banking system client application from the banking system 500 or from a distinct application server. In other embodiments of the invention, the user 210 interacts with the banking system 500 via the web browser application 322 in addition to, or instead of, the transaction monitor client application 321.

The memory 320 can also store any of a number of pieces of information, and data, used by the mobile device 300 and the applications and devices that make up the mobile device 300 or are in communication with the mobile device 300 to implement the functions of the mobile device 300 and/or the other systems described herein. For example, the memory 320 may include such data as user authentication information, etc.

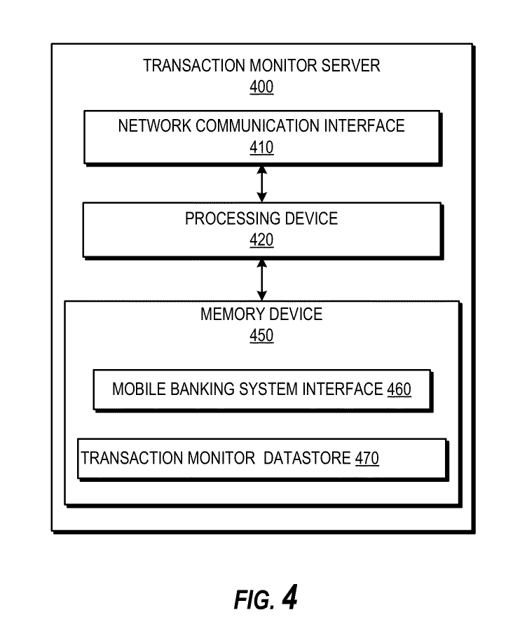

FIG. 4 provides a block diagram illustrating a transaction monitor server 400, in accordance with an embodiment of the invention. In one embodiment of the invention, the transaction monitor server 400 is operated by a second entity that is a different or separate entity from the first entity (e.g., the financial institution) that, in one embodiment of the invention, implements the banking system 500. In one embodiment, the transaction monitor server 400 could be part of the banking system 500. In another embodiment, the transaction monitor server 400 is a distinct entity from the banking system 500. As illustrated in FIG. 4, the transaction monitor server 400 generally includes, but is not limited to, a network communication interface 410, a processing device 420, and a memory device 450. The processing device 420 is operatively coupled to the network communication interface 410 and the memory device 450. In one embodiment of the transaction monitor server 400, the memory device 450 stores, but is not limited to, a mobile banking system interface 460 and a transaction monitor datastore 470. The transaction monitor datastore 470 stores data including, but not limited to, transaction data associated with accounts of the user 210, spending category data, user preferences, and the like. In one embodiment of the invention, both the mobile banking system interface 460 and the transaction monitor datastore 470 may associate with applications having computer-executable program code that instructs the processing device 420 to operate the network communication interface 410 to perform certain communication functions involving the transaction monitor datastore 470 described herein. In one embodiment, the computer-executable program code of an application associated with the transaction monitor datastore 470 may also instruct the processing device 420 to perform certain logic, data processing, and data storing functions of the application associated with the transaction monitor data store 470 described herein.

The network communication interface 410 is a communication interface having one or more communication devices configured to communicate with one or more other devices on the network 250. The processing device 420 is configured to use the network communication interface 410 to receive information from and/or provide information and commands to the user's mobile device 300, third party's systems 270, the transaction monitor server 400, the banking system 500, and/or other devices via the network 250. In some embodiments, the processing device 420 also uses the network communication interface 410 to access other devices on the network 250, such as one or more web servers of one or more third-party data providers. In some embodiments, one or more of the devices described herein may be operated by a second entity so that the third-party controls the various functions involving the transaction monitor server 400. For example, in one embodiment of the invention, although the banking system 500 is operated by a first entity (e.g., a financial institution), a second entity operates the transaction monitor server 400 that monitor transaction data and transfers funds.

As described above, the processing device 420 is configured to use the network communication interface 410 to gather data from the various data sources. The processing device 420 stores the data that it receives in the memory device 450. In this regard, in one embodiment of the invention, the memory device 450 includes datastores that include, for example: (1) transaction data, (2) algorithms for determining parameters of a spending category (3) information about sending and receiving users' mobile device numbers, email addresses, customer support phone numbers, or other contact information, which may have been received from the banking system 500; and/or (4) a list of user IDs or authentication data received from the banking system 500.

In some embodiments of the invention, the transaction monitor server 400 is configured to be controlled and managed by one or more third-party data providers (not shown in FIG. 2) over the network 250. In other embodiments, the transaction monitor server 400 is configured to be controlled and managed over the network 250 by the same entity that maintains the financial institution's banking system. In other embodiments, the transaction monitor server 300 is configured to be controlled and managed over the network 250 by the financial institution implementing the mobile payment system of the present invention. In still other embodiments, the transaction monitor server 400 is a part of the banking system 500.

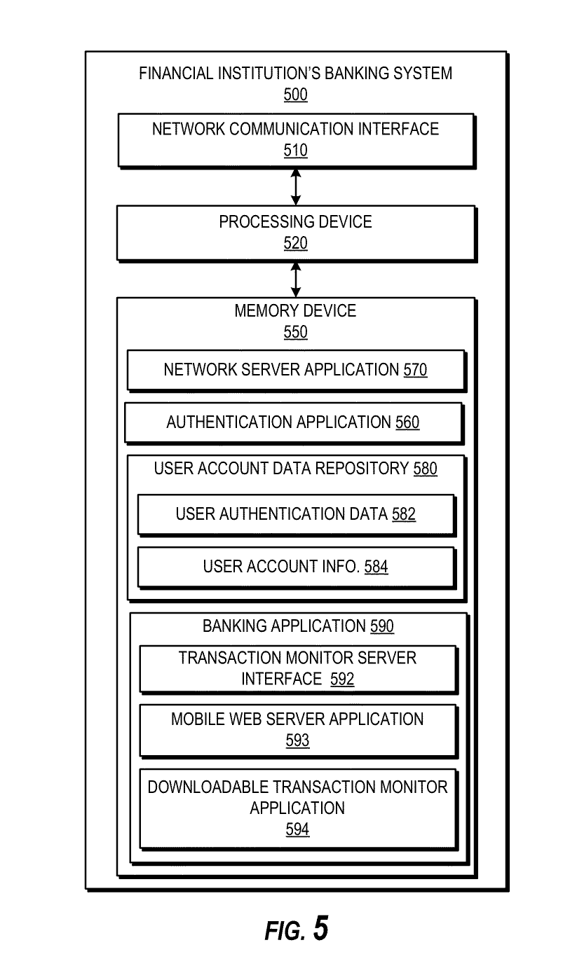

FIG. 5 provides a block diagram illustrating the banking system 500 in greater detail, in accordance with embodiments of the invention. As illustrated in FIG. 5, in one embodiment of the invention, the banking system 500 includes a processing device 520 operatively coupled to a network communication interface 510 and a memory device 550. In certain embodiments, the banking system 500 is operated by a first entity, such as a financial institution, while in other embodiments the banking system 500 is operated by an entity other than a financial institution.

It should be understood that the memory device 550 may include one or more databases or other data structures/repositories. The memory device 550 also includes computer-executable program code that instructs the processing device 520 to operate the network communication interface 510 to perform certain communication functions of the banking system 500 described herein. For example, in one embodiment of the banking system 500, the memory device 550 includes, but is not limited to, a network server application 570, an authentication application 560, a user account data repository 580, which includes user account data repository 580 and user account information 584, a banking application 590, which includes a transaction monitor interface 592, a mobile web server application 593, a downloadable transaction monitor application 594, and other computer-executable instructions or other data. In some embodiments the banking application 590 comprises a mobile web server application 593 that allows the user 210 to change user preferences. The computer-executable program code of the network server application 570, the authentication application 560, or the banking application 590 may instruct the processing device 520 to perform certain logic, data-processing, and data-storing functions of the banking system 500 described herein, as well as communication functions of the banking system 500.

In one embodiment, the user account data repository 580 includes user authentication data 582 and user account information 584. The network server application 570, the authentication application 560, and the banking application 590 are configured to implement user account information 584 in collaboration with the user authentication data 582 and the transaction monitor interface 592 when authenticating the user 210 to the banking system 500.

As used herein, a “communication interface” generally includes a modem, server, transceiver, and/or other device for communicating with other devices on a network, and/or a user interface for communicating with one or more users 210. Referring again to FIG. 5, the network communication interface 510 is a communication interface having one or more communication devices configured to communicate with one or more other devices on the network 250, such as the mobile device 300, the banking system 500, the other financial institution banking systems 270, and the transaction monitor server 400. The processing device 520 is configured to use the network communication interface 510 to transmit and/or receive data and/or commands to and/or from the other devices connected to the network 250.

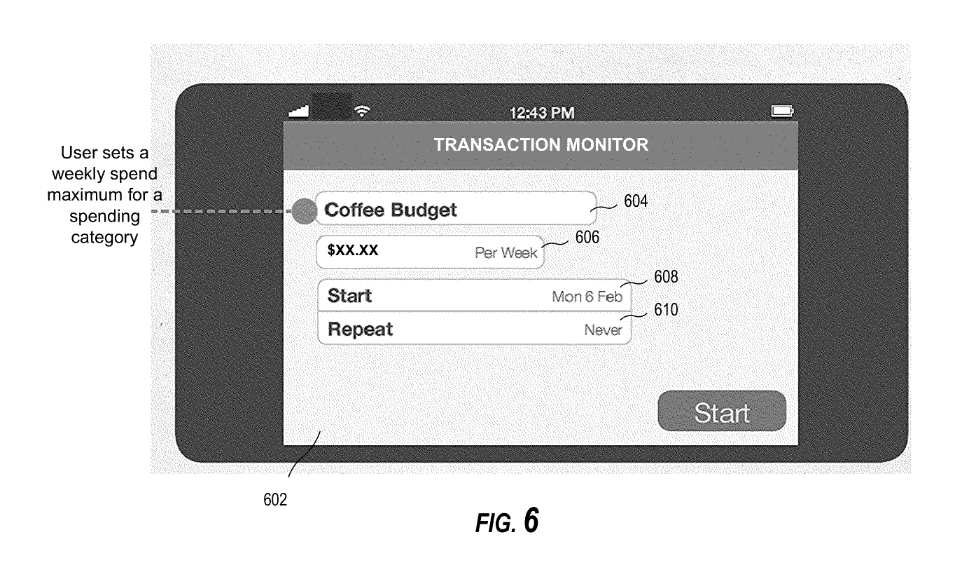

FIGS. 6-8 are examples of graphical user interfaces (GUI's) on the display of a user's mobile device illustrating a process of monitoring transactions. The GUI's are provided by an application stored on the mobile device, such as the transaction monitor client application 321. In the illustrated embodiments, the transaction monitor application 594 is entitled “Transaction Monitor.” The application, in some embodiments, prompts the user 210 to set up an account or provided login information such as a user name and personal identification number when the user 210 opens the application.

In FIG. 6, an exemplary GUI 602 is provided. The GUI 602 includes a spending category field 604, a spending maximum field 606, a period of time field 608, and a repeat field 610. In spending category field 604, the user 210 may input the name of the spending category or may select a spending category from a list of categories provided by the transaction monitor application 594. In the spending maximum field 606, the user 210 may input a weekly spend maximum amount or the spend maximum amount may be automatically generated by the transaction monitor application 594 upon selection of the spending category.

The user 210 may find that monitoring transactions on a weekly basis may be less cumbersome than monitoring transactions over a longer period because weekly goals may be easier to reach. However, the application may run over any period of time. In the period of time field 608, the user 210 inputs the start date of the transaction monitoring process or the start date may default to a certain date, such as the start of the work week or the day the user 210 accesses the application. In further embodiments, the user 210 inputs the start time. In the repeat field 610, the user 210 can select whether to repeat the transaction monitoring process. For example, the user 210 may designate that the application should continue to monitor transactions always, never, every other week, or the like. The user 210 can click on the “Start” button to launch the transaction monitoring process.

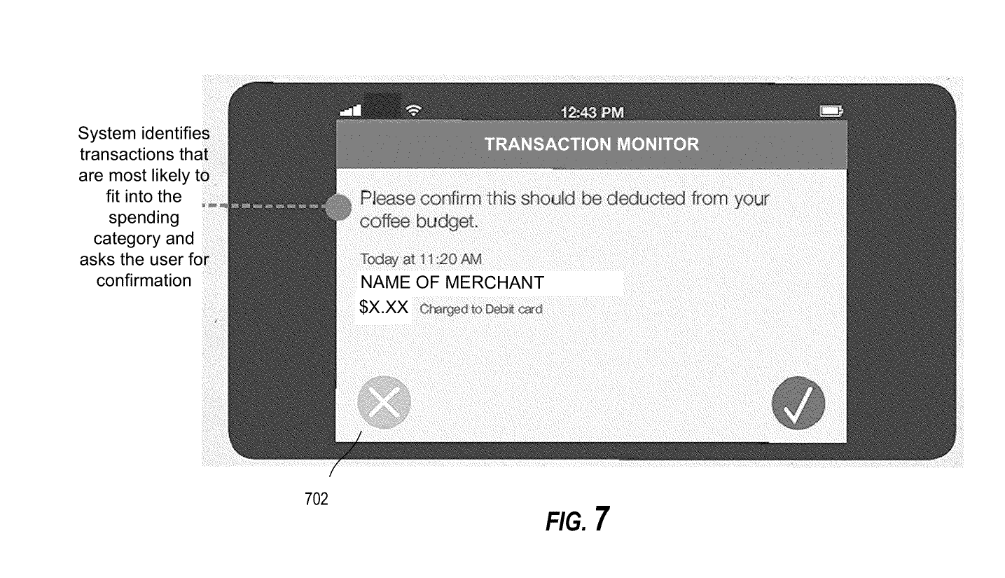

Referring now to FIG. 7, an exemplary GUI 702 is provided. The GUI 702 comprises a confirmation prompt and details about the transaction that has been identified as being associated with the “Coffee budget” spending category. In FIG. 7, the application provides the date and time of the transaction, the name of the merchant, and the amount charged to a debit card. In some embodiments, the application may further provide the identification of the item purchased and/or information associated with past transactions. The user 210, in the illustrated embodiment, confirms the transaction by selecting the check button.

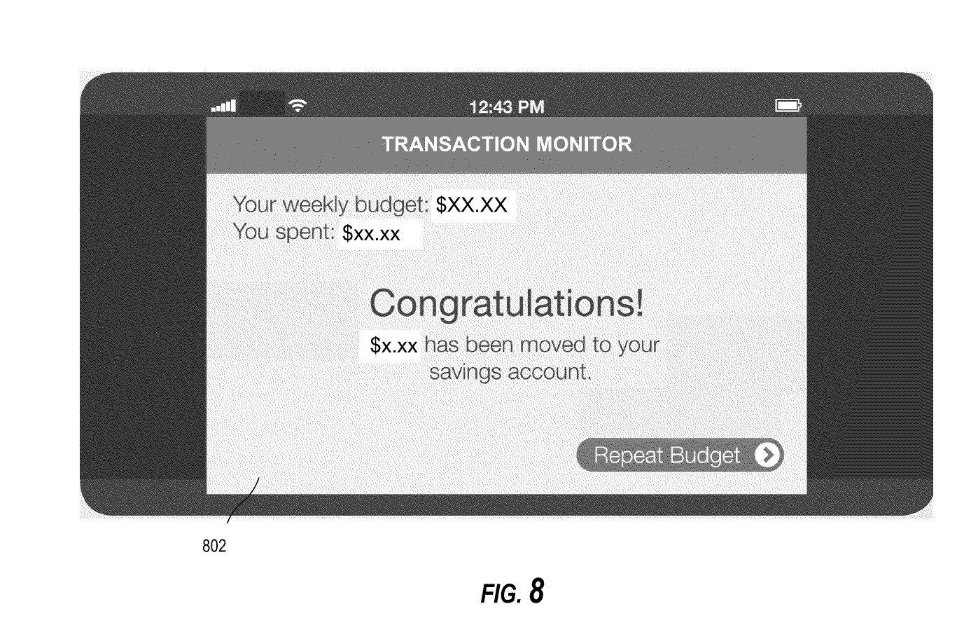

In FIG. 8, the transaction monitoring process continues as provided in GUI 802. The user 210 is notified of the spend maximum, the total amount spent during the week, and the surplus amount that has been moved to a savings account. For example, if the weekly budget was set at $20.00 and the amount actually spent by the user 210 was $12.35, $7.65 would be deposited into the designated savings account. In some embodiments, the GUI 802 further provides a field for amending the amount to be transferred to the savings account and/or a field for modifying the account that is to receive the transfer amount. In other embodiments, the application allows the user 210 to stop the transaction monitoring process.

This application incorporates by reference in their entirety each of the following applications filed concurrently herewith:

U.S. application Ser. No. 13/543,694, entitled BILL CONTROL, filed Jul. 6, 2012 to Carrie Hanson et al. (Atty. Dkt. 5163US1.014033.1650);

U.S. application Ser. No. 13/543,644, entitled ELECTRONIC PROCESSING OF PAPER INVOICES, filed Jul. 6, 2012 to Carrie Hanson et al. (Atty. Dkt. 5168US1.014033.1660);

U.S. application Ser. No. 13/543,676, entitled FINANCIAL DOCUMENT PROCESSING SYSTEM, filed Jul. 6, 2012 to Carrie Hanson et al. (Atty. Dkt. 5169US1.014033.1661);

U.S. application Ser. No. 13/543,700, entitled BILL PAYMENT MANAGEMENT, filed Jul. 6, 2012 to Carrie Hanson et al. (Atty. Dkt. 5173US1.014033.1662);

U.S. application Ser. No. 13/543,651, entitled EARNING REWARDS VIA BILL PAYMENT, filed Jul. 6, 2012 to Carrie Hanson et al. (Atty. Dkt. 5174US1.014033.1649);

U.S. application Ser. No. 13/543,696, entitled FUTURE ACCOUNT VIEW, filed Jul. 6, 2012 to Carrie Hanson et al. (Atty. Dkt. 5175US1.014033.1651); and

U.S. application Ser. No. 13/543,649, entitled CALENDAR BILL PAYMENT MANAGEMENT, filed Jul. 6, 2012 to Carrie Hanson et al. (Atty. Dkt. 5190US1.014033.1652).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A system for monitoring categorized spending limits maximums, the system comprising:
a computer apparatus including a processor and a memory; and
a spending monitor software module stored in the memory, comprising executable instructions that when executed by the processor cause the processor to:
receive transaction data associated with a first account retained by a user;
store the transaction data in a storage device;
identify transactions associated with a spending category that occur during a first period of time based on the transaction data, wherein the spending category comprises a maximum amount;
deduct a transaction amount for each of the transactions from the maximum amount;
calculate a remaining amount as a first difference of the total transaction amount of all of the identified transactions and the maximum amount based on the deduction, wherein the total transaction amount is less than the maximum amount and transfer at least a portion of the remaining amount to a second account, the second account being retained by the user or retained by a third party; and
calculate a second amount as a second difference of the total transaction amount of all of the identified transactions and the maximum amount based on the deduction, wherein the total transaction amount is greater than the maximum amount and deduct additional funds equal to at least a portion of the second difference from the first account.

2. The system of claim 1, wherein the module is further configured to:
provide a confirmation prompt on a display of a mobile device of the user that is in communication with the system; wherein the deducting the transaction amount for each of the transactions occurs in response to receiving a confirmation from the user.

3. The system of claim 2, wherein the module is further configured to:
calculate the total number of the transactions; and
determine that the total number of transactions is above a threshold number, wherein the transfer of at least a portion of the remaining amount to a second account is in response to determining the total number of transaction is above the threshold number.

4. The system of claim 1, wherein the module is further configured to:
transfer a first portion of the remaining amount to the second account and a second portion of the remaining amount to a third account,
wherein the second account is retained by the user and the third account is retained by the third party.

5. The system of claim 4, wherein the transfer of the first portion of the remaining amount comprises an internal transfer and the transfer of the second portion of the remaining amount comprises an external transfer.

6. (canceled)

7. The system of claim 1, wherein the module is further configured to:
deduct an additional amount equal to the additional funds from a second maximum amount associated with a second spending category.

8. (canceled)

9. The system of claim 1, wherein the module is further configured to:
deduct funds equal to at least a portion of the second difference from the maximum amount for transactions associated with the spending category that occur during a second period of time, wherein the first period of time is prior to the second period of time.

10. The system of claim 1, wherein the module is further configured to:
recommend an increase in the maximum amount to the user.

11. The system of claim 1, wherein the module is further configured to:
identify a group of transactions that occur during a second period of time that is prior to the first period of time;
identify parameters based on the group of transactions, wherein the parameters comprise a transaction channel, a merchant, an amount, or a transaction item; and
determine the spending category based on the parameters.

12. The system of claim 11, wherein the module is further configured to:
segregate the group of transactions into categories based on the parameters;
calculate the total amount for each of the categories; and
determine the maximum amount based on at least one of the total amount calculations.

13. The system of claim 1, wherein the module is further configured to:
determine that the spending category comprises subcategories based on transaction items or a merchant associated with the transactions;
segregate the transactions into each of the subcategories;
calculate the total number or value of the transactions for each of the subcategories; and
provide a notification to the user based on the calculation of the total number or value of the transactions for confirmation to deduct the transaction amounts for each of the transactions from the maximum amount.

14. A computer program product for monitoring categorized spending maximums, the computer program product comprising:
a non-transitory computer readable storage medium having computer readable program code embodied therewith, the computer readable program code comprising:
a computer readable program code configured to receive transaction data associated with a first account retained by a user;
a computer readable program code configured to identify transactions associated with a spending category that occur during a period of time based on the transaction data, wherein the spending category comprises a maximum amount;
a computer readable program code configured to deduct a transaction amount for each of the transactions from the maximum amount in response to receiving a confirmation from the user;
a computer readable program code configured to:
calculate a remaining amount as a first difference of the total transaction amount of all of the identified transactions and the maximum amount based on the deduction, wherein the total transaction amount is less than the maximum amount and transfer at least a portion of the remaining amount to a second account, the second account being retained by the user or retained by a third party; and
calculate a second amount as a second difference of the total transaction amount of all of the identified transactions and the maximum amount based on the deduction, wherein the total transaction amount is greater than the maximum amount and deduct additional funds equal to at least a portion of the second difference from the first account.

15. The computer program product of claim 14, further comprising computer readable program code configured to transfer a first portion of the remaining amount to a second account and a second portion of the remaining amount to a third account.

16. A method for monitoring categorized spending maximums, the method comprising:
receiving transaction data associated with a first account retained by a user;
identifying, via a computing device processor, transactions associated with a spending category that occur during a period of time based on the transaction data, wherein the spending category comprises a maximum amount;
providing, via a computing device processor, a confirmation prompt on a display of a mobile device of the user;
deducting, via a computing device processor, a transaction amount for each of the transactions from the maximum amount in response to receiving a confirmation from the user;
calculating, via a computing device processor, a remaining amount as a first difference of the total transaction amount of all of the identified transactions and the maximum amount based on the deduction, wherein the total transaction amount is less than the maximum amount and transfer at least a portion of the remaining amount to a second account, the second account being retained by the user or retained by a third party; and
calculating, via a computing device processor, a second amount as a second difference of the total transaction amount of all of the identified transactions and the maximum amount based on the deduction, wherein the total transaction amount is greater than the maximum amount and deduct additional funds equal to at least a portion of the second difference from the first account.

17. The method of claim 16, the method further comprising:
transferring, via a computing device processor, a first portion of the remaining amount to the second account and a second portion of the remaining amount to a third account,
wherein the second account is retained by the user and the third account is retained by the third party.

18. The method of claim 17, wherein the transfer of the first portion of the remaining amount comprises an internal transfer and the transfer of the second portion of the remaining amount comprises an external transfer.

19. The method of claim 16, the method further comprising:
receiving user defined input from the user; and
modifying the remaining amount in accordance with the user defined input.

20. The method of claim 16, wherein the transaction data is received from a point of sales device.
